(19) United States
(12) Patent Application Publication
(10) Pub. No.: US 2005/0069256 A1
(43) Pub. Date: Mar. 31, 2005

(54) Lensed optical fiber and method for making the same

(75) Inventors: Robert M. Jennings, Austin, TX (US); John T. Cowher, Leander, TX (US); Stephen P. Leblanc, Austin, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/670,630

(22) Filed: Sep. 25, 2003

(51) Int. Cl. G02B 6/32

(52) U.S. Cl. 385/33

(57) ABSTRACT

An optical fiber having a microlens on an end thereof. The microlens is fabricated by drawing the end of the optical fiber over an abrasive media in a curvilinear pattern, such as a spiral curvilinear pattern.

### BACKGROUND

The present invention relates to the optical coupling between a light source and an optical fiber. More particularly, the invention relates to an optical fiber having an integral microlens, and a method for forming microlenses of many different shapes on optical fibers of many diverse types.

Optical fiber technology is used in widely diverse applications. The use of optical fiber technology requires the optical fiber to gather light directed at the end of the fiber. The ability of the optical fiber to gather light is referred to as the coupling efficiency of the fiber. It is desired that as much light as possible be gathered by the optical fiber. For light to enter into an optical fiber from a light source, the light source and optical fiber are generally coupled by aligning the end of the optical fiber with the light source. However, due to divergence in the angle of emission of light from the light source, the coupling efficiency with optical fibers can be improved. Consequently, there is a need to improve the coupling efficiency between the light source and the optical fiber. It is known that the coupling efficiency can be improved dramatically by the use of a lens at the fiber end.

Numerous techniques are known for forming lenses at the ends of optical fibers. In some applications, discrete lenses are attached to the fiber end (for example, see U.S. Pat. Nos. 4,269,648; 4,380,365; 4,118,270 and 4,067,937). It is also known that a lens may be fabricated directly on the end of an optical fiber. This approach is generally preferable to attachment of a discrete lens because of its relative mechanical simplicity and freedom from complicated lens/fiber alignment procedures.

Direct lens fabrication techniques include cleaving the optical fiber to a square edge and then etching the end of the fiber (such as in an acidic solution) to form a rounded lens thereon (see U.S. Pat. No. 4,118,270 to Pan et al.). Another technique includes heating the optical fiber and pulling its ends so as to form a narrow waist, then cleaving the fiber at its waist to form a long substantially conically tapered lens (see U.S. Pat. No. 4,589,897 to Mathyssek et al.). Another technique for forming a lens on an optical fiber end is to heat the end of the fiber to its melting point to produce a rounded surface. Yet another technique includes abrasive lapping of the end of the optical fiber to achieve a conical lens (see U.S. Pat. No. 4,818,263 to Mitch) or wedge-shaped lens (see U.S. Pat. No. 5,845,024 to Tsushima et al.). In addition, these various techniques may be combined, for example, by abrasive lapping and then heating of the end of the optical fiber.

A variety of problems plague the known techniques for directly fabricating a lens on the end of an optical fiber. One problem is that many fabrication techniques are useful for forming only a limited range of lens shapes. Also, many prior art fabrication techniques are unable to form unusual lens shapes, or unable to form lenses on optical fibers having unusual geometries. Although most optical fibers have a circular core positioned in the center of the fiber cladding, other optical fiber geometries are also known. For example, some optical fibers have cores that are not circular in cross-section or that are not centered within the cladding. Prior art lensing techniques are typically unsuited for use with optical fibers having asymmetric geometries.

In addition to unusual fiber and lens geometries, some optical fibers, such as polarization maintaining (PM) fibers, include regions adjacent the fiber core that are highly doped with alumina or other material to induce a stress in the fiber that induces birefringence. These highly doped regions do not heat or etch at the same rate as the glass in other portions of the optical fiber. This difference interferes with the formation of lenses on these fibers by known techniques.

### SUMMARY

The present invention is an optical fiber having a lens integrally formed on an end of the optical fiber, and a method of fabricating a lens on the end of an optical fiber. The present invention is useful for forming diverse lens geometries and may be used with optical fibers having many different constructions and geometries.

In one aspect of the invention, the lens on the optical fiber has a finite radius of curvature in a first direction and a finite radius of curvature in a second direction orthogonal to the first direction. The radius of curvature in the first direction is different from the radius of curvature in the second direction, and at least one of the first and second directions is non-orthogonal to a longitudinal axis of the optical fiber. A transverse cross-section of the optical fiber has anisotropic physical properties according to one embodiment of the invention. According to another embodiment of the invention, the transverse cross-section of the optical fiber does not have anisotropic physical properties. According to another embodiment of the invention, the transverse cross-section of the optical fiber is non-circular.

In another aspect of the invention, the lens is formed on the optical fiber by drawing the tip of the optical fiber over an abrasive media in a spiral curvilinear pattern. The curvilinear pattern is shaped to abrade the tip of the optical fiber such that the result is the desired lens shape. In one embodiment according to the invention, the curvilinear pattern is shaped to compensate for asymmetric physical properties in the transverse cross-section of the optical fiber.

In another aspect of the invention, the lens is formed on the optical fiber by drawing the tip of the optical fiber over an abrasive media in a curvilinear pattern that is selected from the group consisting of substantially oval patterns, substantially elliptical patterns, substantially egg-shaped patterns, substantially pill-shaped patterns, and substantially iron-shaped patterns.

### BRIEF DESCRIPTION OF THE DRAWINGS

FIGS. 1A and 1B are schematic cross-sections of one exemplary embodiment of a lensed optical fiber according to the present invention.

FIGS. 2A and 2B are schematic cross-sections of another exemplary embodiment of a lensed optical fiber according to the present invention.

FIGS. 3A-3D schematically illustrate an optical fiber in a holding fixture during fabrication of a microlens according to the present invention.

FIG. 4 is a graph of the optical fiber tip contact angle for exemplary free lengths of optical fiber.

FIGS. 5A-5D illustrate exemplary fiber abrasion patterns according to the present invention.

FIG. 6 illustrates a fiber abrasion pattern used to fabricate an exemplary lensed optical fiber according to the present invention.

FIGS. 7A-7B are photographs of the lensed optical fiber fabricated using the fiber abrasion pattern of FIG. 6.

FIG. 7C is the farfield pattern of the lensed optical fiber of FIGS. 7A-7B.

FIG. 8 illustrates a fiber abrasion pattern used to fabricate another exemplary lensed optical fiber according to the present invention.

FIGS. 9A-9B are photographs of the lensed optical fiber fabricated using the fiber abrasion pattern of FIG. 8.

FIG. 9C is the farfield pattern of the lensed optical fiber of FIGS. 9A-9B.

### DETAILED DESCRIPTION

One purpose of a lens on an optical fiber is to route light from a light source into the core of the optical fiber as efficiently as possible. Typically, the light produced from the light source diverges. The divergent light pattern may take nearly any shape. The generated light pattern may be a generally circular shape, but more often takes a generally elliptical shape. In the case of a generally elliptically shaped light pattern, cylindrical lenses are usually employed because cylindrical lenses couple the light more efficiently than conical or spherical lenses. However, cylindrical lenses are not completely efficient, because light at the extreme ends of the light source ellipse is not coupled into the optical fiber core, but rather coupled into the cladding of the optical fiber. The light directed into cladding of the optical fiber is therefore lost. To increase the lens coupling efficiency, a biconic lens shape is required to capture this extra light and focus it into the core. As used herein, a biconic lens shape is a lens having a finite maximum radius of curvature along a first axis, and a finite radius of curvature along a second axis orthogonal to the first axis, where the radii of curvature are different from each other. As used herein, spherical lenses, conical lenses and cylindrical lenses are excluded from biconic lens shapes, as they either have at least one radius of curvature which is not finite (e.g., a cylindrical lens), or have radii of curvature that are not different from each other (e.g., conical and spherical lenses).

In other instances, a spherical, conical or cylindrical lens is desired, but the lens is required on an optical fiber having a transverse cross-section with anisotropic physical properties. The anisotropic physical properties in the transverse cross-section of the optical fiber make it very difficult or impractical to fabricate a spherical or conical lens shape on the optical fiber using prior mechanical fabrication techniques. As used herein, “anisotropic physical properties” refer to those properties of an optical fiber that differ depending upon the direction measured in the transverse cross-section of the optical fiber. For example, the bending stiffness or abrasion resistance of an optical fiber may vary in different directions across the transverse cross-section of the fiber. As an example, using abrasion techniques as shown in U.S. Pat. No. 4,818,263 to Mitch, it is difficult to produce a truly conical lens on a polarization maintaining optical fiber because the bending stiffness of the fiber varies with rotation about the fiber axis. As a result, attempts to produce a conical lens on polarization maintaining fibers often produce elliptical lens patterns with variations in the major and minor radius by as much as 40%. One aspect of the present invention allows the fabrication of a wide variety of lens shapes on many diverse types of optical fibers.

Specific types of optical fibers with which the present invention may be successfully employed include polarizing maintaining (PM) optical fibers and polarizing (PZ) optical fibers. Polarization maintaining (PM) optical fiber is a single mode optical fiber that is designed to have a large internal birefringence caused by geometric and stress effects in the fiber. The polarization state of linearly polarized light that is launched on a birefringent axis is maintained as is propagates along the fiber. Polarizing (PZ) optical fiber is a highly birefringent, single mode optical fiber that is designed so that one polarization state has much higher loss than another. Unpolarized light that is launched in to the PZ fiber will emerge as polarized light.

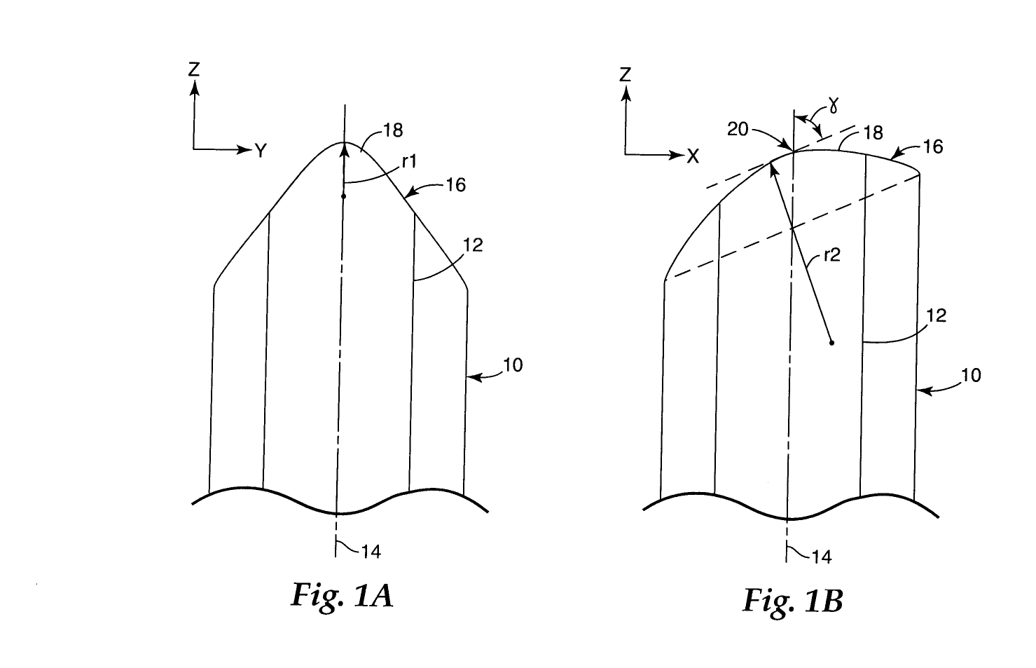

FIGS. 1A and 1B illustrate one embodiment of a lensed optical fiber 10 according to the invention. Optical fiber 10 has a core 12 centered on its longitudinal axis 14. At one end 16 of optical fiber 10, a microlens 18 is formed. The embodiment of microlens 18 illustrated in FIGS. 1A and 1B has a biconic lens shape that may generally be described as an oblate spheroid. Specifically, microlens 18 has a finite radius of curvature r1 in a first direction (FIG. 1A) and a finite radius of curvature r2 in a second direction orthogonal to the first direction (FIG. 1B). The radius of curvature r1 in the first direction is different from the radius of curvature r2 in the second direction. The radii of curvature r1 and r2 are selected according to the shape of the light source, such that coupling efficiency of microlens 18 is optimized. In some embodiments according to the invention, the surface of microlens 18 has a continuous curvature, with no discontinuous surfaces on the microlens 18.

In one embodiment according to the invention, as also seen in FIGS. 1A and 1B, at least one of the first and second directions is at a non-orthogonal angle γ to the longitudinal axis 14 of the optical fiber 10. At least one of the first and second directions is non-orthogonal to the longitudinal axis 14 of the optical fiber 10 to prevent or reduce back-reflection of light into the light source (not shown). Back reflection of light into the light source may adversely affect the output of the light source. To reduce this problem, microlens 18 may be formed such that the apex 20 of microlens 18 is not orthogonal to the fiber axis 14, but rather lies at an angle γ with respect to the fiber axis 14. The angle γ is usually between 800 and 85° to the fiber axis 14.

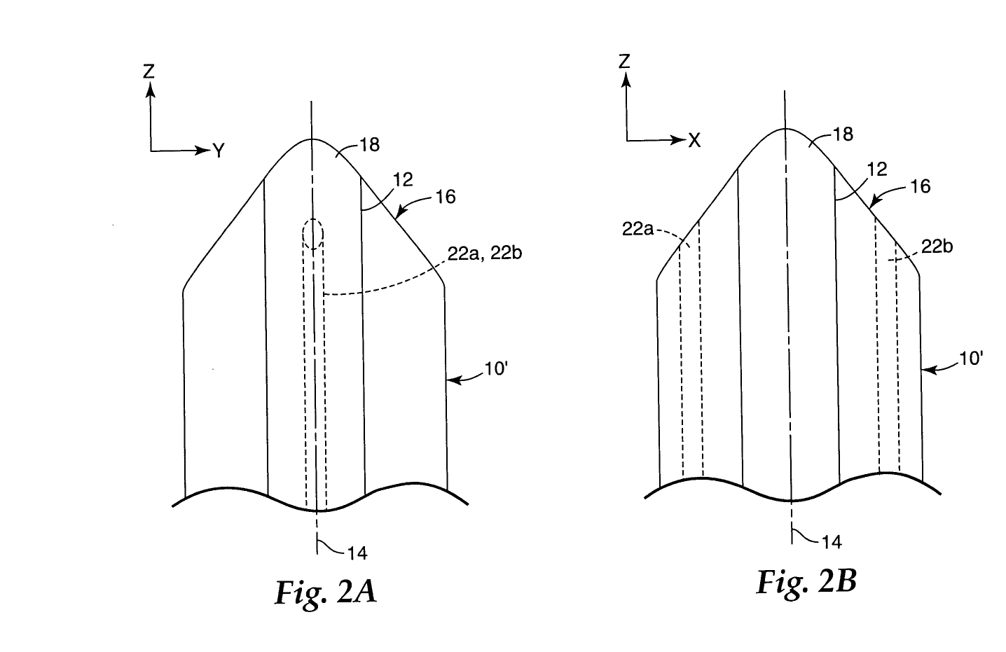

FIGS. 2A and 2B illustrate another embodiment of a lensed optical fiber 10′ according to the invention. The optical fiber 10′ shown in FIGS. 2A and 2B has a transverse cross-section with anisotropic physical properties. Specifically, optical fiber 10′ has a core 12 centered on its longitudinal axis 14. Doped regions 22a, 22b extend on opposite sides of core 12. Doped regions 22a, 22b cause fiber 10′ to have, for example, different bending stiffness and abrasion resistance in the X and Y directions of its transverse cross-section. The anisotropic physical properties of fiber 10′ may also exist if, for example, optical fiber 10′ has a non-circular cross-section instead of, or in addition to, the doped regions 22a, 22b. At one end 16 of optical fiber 10′, a microlens 18 is formed. The microlens 18 embodiment illustrated in FIGS. 2A and 2B is symmetrically positioned about the longitudinal axis 14 of the fiber 10′. Specifically, microlens 18 is a conical lens centered on the longitudinal axis 14 of optical fiber 10′. In alternate embodiments according to the invention, microlens 18 may have a symmetric shape but be asymmetrically fabricated on optical fiber 10′ (for example, a conical lens fabricated at an angle γ to fiber axis 14), or a biconic lens shape as illustrated in FIGS. 1A and 1B fabricated on optical fiber 10′.

The lensed optical fibers described herein may be fabricated across a wide range of lens shapes and on a wide range of optical fiber constructions using the fabrication technique according to the invention, in which a tip of the optical fiber is drawn over a flat abrasive media in a curvilinear pattern, as further described below.

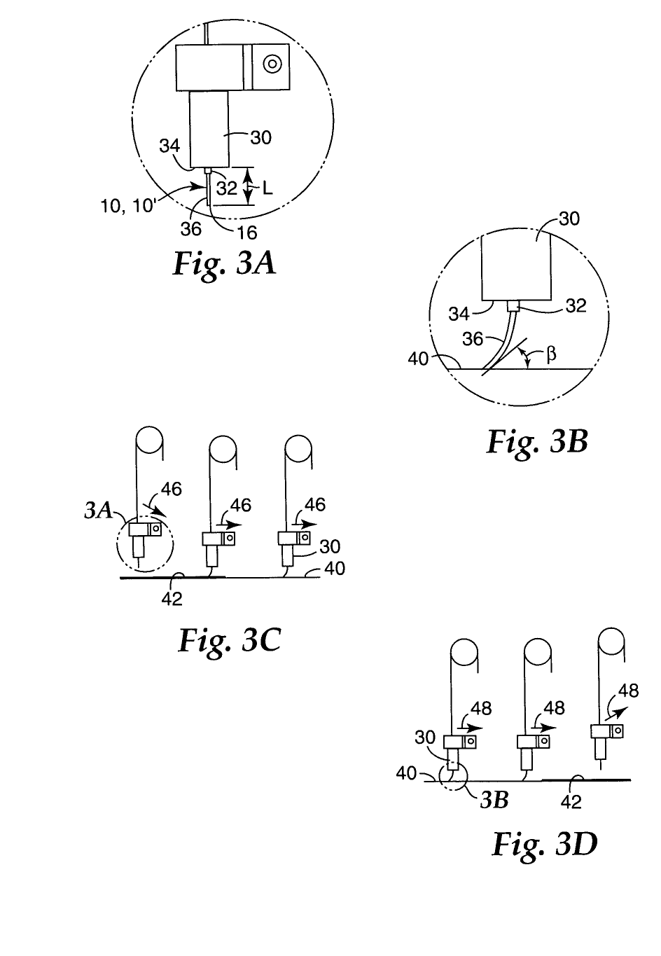

Referring now to FIGS. 3A-3D, the fabrication of lensed optical fibers according to the invention begins by securing an optical fiber 10, 10′ in a holding fixture 30 that grips the outer coating 32 of the optical fiber 10, 10′. The holding fixture 30 may be of any suitable design. The holding fixture 30 must secure the optical fiber 10, 10′ with enough compressive force to eliminate any rotational or lateral movement of the optical fiber 10, 10′ without crushing the outer coating 32 of the optical fiber 10, 10′ or significantly distorting the direction of the optical fiber 10, 10′ as it exits the holding fixture 30. Holding fixture 30 can ensure that a precise length of fiber 10, 10′ protrudes from the holding fixture 30 after cleaving of the optical fiber. The holding fixture 30 may be, for example, a collet that clamps the optical fiber. In a preferred embodiment according to the invention, approximately 6 mm of optical fiber 10, 10′ is left protruding from the end 34 of the holding fixture 30 for processing.

Prior to forming a lens 18 on the end of the optical fiber 10, 10′, the outer coating 32 of the protruding fiber 10, 10′ is stripped off of the optical fiber via either mechanical or chemical means. A short length of the outer coating 32 is optionally left protruding from the end 34 of the holding fixture 30. The short length of outer coating 32 acts as a protective sleeve and also as a strain relief mechanism for the protruding length of bare glass fiber 36 during the remainder of the lensing process.

The protruding bare glass fiber 36 is next cleaved to leave a desired free length L using a fiber optic cleaver as is commonly available. A free length L remains protruding from the holding fixture 30. A preferred free length L of glass fiber 36 will depend upon the fiber properties, such as diameter and bending stiffness. The minimum free length L of glass fiber 36 is dictated by the width of the cleaver blade, and may be as small as 1 mm.

The holding fixture 30 with its secured optical fiber 10, 10′ is then mounted to a movable stage (not shown). The movable stage moves the holding fixture 30 and fiber tip 16 relative to an abrasive media 40 along a programmed path within a three dimensional space bounded by the travel limits of the movable stage. When working with an optical fiber 10′ having a transverse cross-section with anisotropic physical properties, the orientation of the optical fiber 10′ relative to the movable stage depends upon the lens design (i.e., the orientation of the anisotropic physical properties relative to the direction of the stage movement should be known).

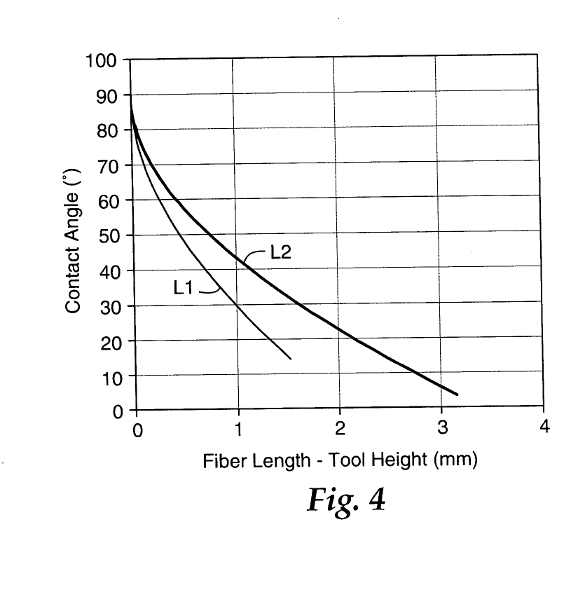

After holding fixture 30 and optical fiber 10, 10′ are secured to the moveable stage, the tip 16 of optical fiber 10, 10′ is dragged across abrasive surface 40 in a predetermined curvilinear pattern to remove material from the fiber tip. As the optical fiber 10, 10′ is dragged across the abrasive media 40, the optical fiber 10, 10′ bends and the tip 16 of the fiber 10, 10′ becomes oriented at a precise contact angle β with respect to the abrasive surface 40 (FIG. 3B). This contact angle β is controlled by the free length L of the optical fiber protruding out of the holding fixture 30 and the distance between the abrasive surface 40 and the end 34 of the holding fixture 30. FIG. 4 shows a plot of the fiber tip contact angle β verses the distance between end 34 of holding fixture 30 and abrasive surface 40 for two different free fiber lengths (L1=3.8100 mm and L2=6.2230 mm).

Thus, according to an exemplary embodiment, the contact pressure exerted on the tip of the fiber and the contact angle can be controlled by one or more of the following parameters: the free-fiber length (L) of unsupported fiber, the distance between the end of the holding fixture and the abrasive surface, and the physical properties of the fiber (e.g., bending stiffness, diameter, composition).

The fiber tip 16 rotates with vertical position of the holding fixture 30. Thus, lowering the fiber tip 16 into position at the beginning of the fiber abrasion process and pulling the tip 16 up when finished without creating undesirable artifacts on the lens surface should be addressed. Potential problems can be averted by providing a smooth (non-abrasive) film 42 over the ends of the abrasive media 40 to allow correct positioning of the optical fiber tip 16 as it contacts the abrasive media 40.

As best illustrated by the arrows 46 in FIG. 3C, when starting the fiber abrasion process the optical fiber tip 16 is lowered into vertical position along a diagonal path (generally less than about 15° relative to the abrasive surface 40) over the smooth film 42 to ensure that no material removal occurs while the fiber tip 16 is rotated to the desired contact angle β. After the fiber abrasion process is completed, the fiber tip 16 is lifted off of the smooth film 42 in a similar diagonal path, as indicated by the arrows 48 in FIG. 3D.

After the optical fiber is properly positioned on the abrasive media, the tip 16 of the optical fiber is drawn over a flat abrasive media 40 in curvilinear patterns. By carefully manipulating the curvilinear pattern traced by the fiber tip 16, lenses of many shapes may be created, and any anisotropic physical properties of the optical fiber may be accommodated. For example, when a conical lens is desired on an optical fiber 10′ having a transverse cross-section with anisotropic physical properties (such as a polarization maintaining fiber), the fiber tip 16 may be moved in a curvilinear pattern that offsets the anisotropic properties (e.g., bending stiffness and abrasion resistance) to produce a truly circular conical shaped lens, and thus produce a more efficient lens on the fiber to couple, for example, with a light source.

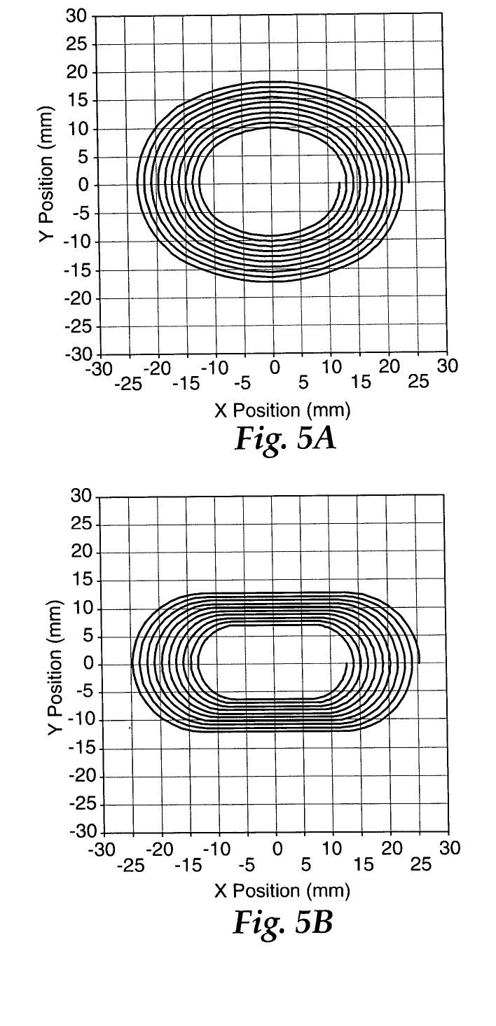

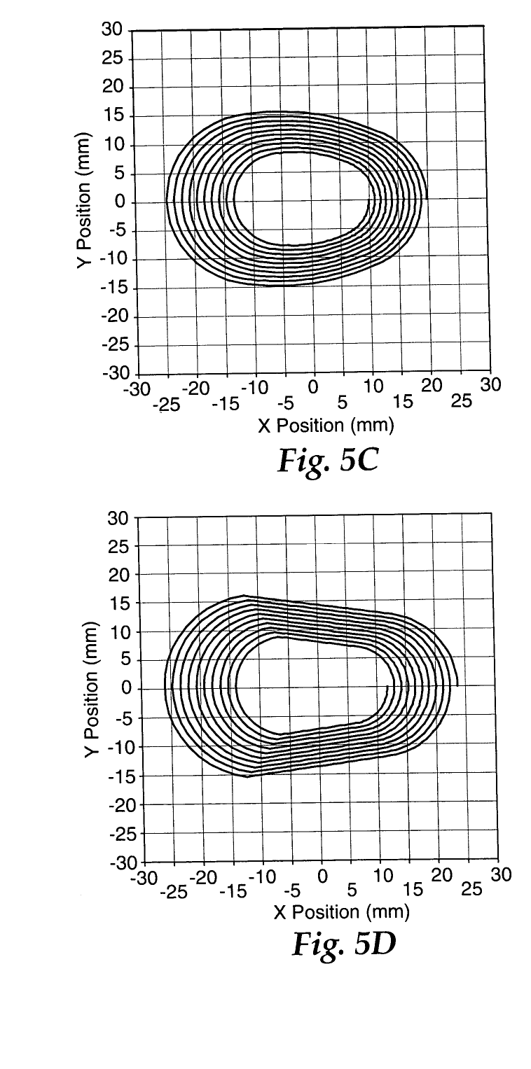

Examples of fiber abrasion patterns are illustrated in FIGS. 5A-5D. FIG. 5A illustrates a generally elliptical abrasion pattern. When used with an optical fiber 10 having isotropic physical properties, the abrasion pattern of FIG. 5A produces a generally conical microlens with unequal orthogonal radii r1, r2. The major axis of the lens is controlled by varying the shape of the elliptical path. For example, by increasing the radius of curvature of the abrasion pattern over the long stretches of the ellipse to create a generally “pill” shaped path as shown in FIG. 5B, the equivalent of a cylindrical lens can be fabricated. By decreasing the radius of curvature of the abrasion pattern, more curvature is created in the lens apex and thereby creates a generally toric shape at the tip of the fiber. The minor axis of the lens may be made using a secondary process, such as heating or etching or mechanically polishing the lens tip.

In alternate fiber abrasion patterns according to the invention, the radius on one end of the generally elliptical pattern may be different from the radius at the opposite end of the pattern to create an “egg” shaped pattern or generally “iron” shaped pattern as shown in FIGS. 5C and 5D, respectively. These fiber abrasion patterns will also produce a generally toric shape at the lens tip, but will cause the apex of the lens to rotate relative to the fiber axis to produce an angled lens. As described above with respect to FIGS. 5A and 5B, increasing the radius of curvature of the abrasion pattern over the long stretches of the ellipse produces the equivalent of an angled cylindrical lens. Similarly, decreasing the radius of curvature creates more curvature at the angled lens apex.

The curvilinear abrasion patterns according to the invention are not limited to the exemplary abrasion patterns of FIGS. 5A-5D. Rather, it is to be understood that any curvilinear pattern may be utilized, depending upon the optical fiber construction and geometry, and the desired shape for the microlens. Additionally, the abrasion patterns need not be spiral patterns in which the abrasion path gradually or continuously recedes from or approaches a pattern center point, as is illustrated in FIGS. 5A-5D. Spiral patterns such as those illustrated are desirable in that the optical fiber tip is always drawn across a “fresh” abrasive surface, and the abrasion rate of the fiber tip is therefore more consistent and predictable. However, it is also contemplated that the abrasion pattern may alternately continually trace the same path on the abrasive media, or may trace the same path for a portion of the abrasion process and spiral for another portion of the abrasion process.

It should be noted that terms used herein describing shapes, such as “ellipse”, “elliptical”, “toric”, “circle”, “circular”, “spiral”, etc., are not intended to be limited by their mathematical definitions, and are rather understood to generally or substantially resemble such shapes.

### EXAMPLE 1

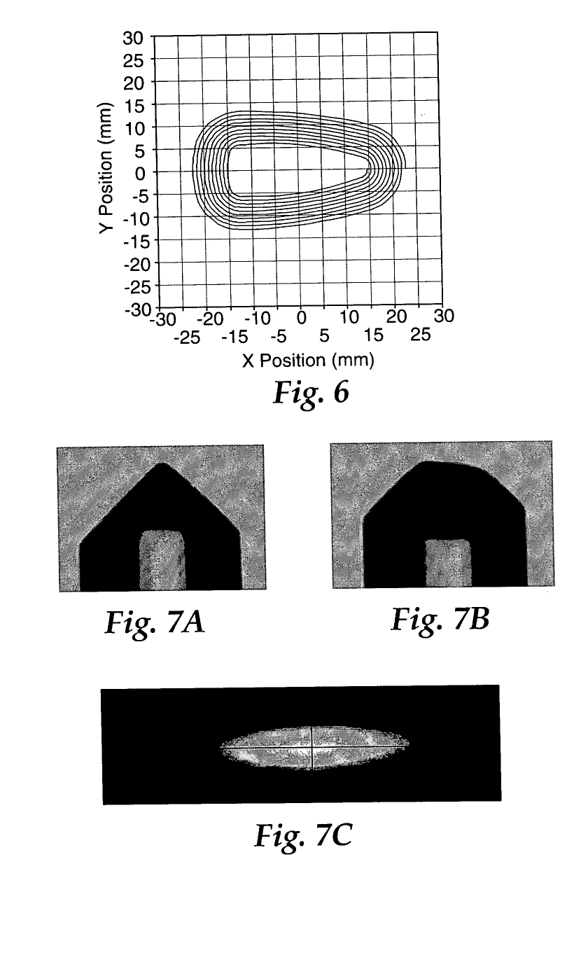

The creation of an angled toric lens with a large torus radius is illustrated in FIGS. 6 and 7A-7C. In this example, an optical fiber with isotropic physical properties was loaded into a collet, with the fiber protruding from the bottom face of the collet by 6.25 mm (0.246 inch). The fiber was drawn across abrasive lapping film in the curvilinear pattern as shown in FIG. 6. The collet to film distance was set at 5.00 mm (0.197 inch). The optical fiber was drawn in 400 cycles across a 0.5 μm diamond lapping film and then 100 cycles across a 0.1 μm diamond lapping film using the same pattern. It should be noted that the curvilinear pattern of FIG. 6 correctly shows the start and end points of the cycles, but the number of cycles illustrated has been reduced for clarity of the Figure. The optical fiber was then removed from the collet, placed in a fiber fusion splice, and subjected to three plasma bursts for 0.5 seconds each at a power setting of 11.5 mA to melt the tip of the lens. Photos of the resulting lens and farfield pattern are shown in FIGS. 7A-7C.

### EXAMPLE 2

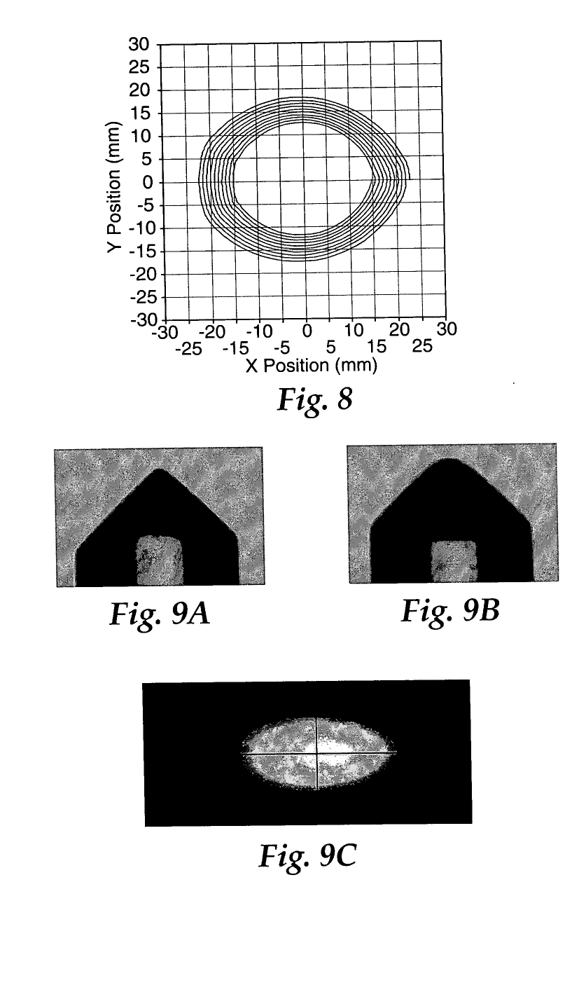

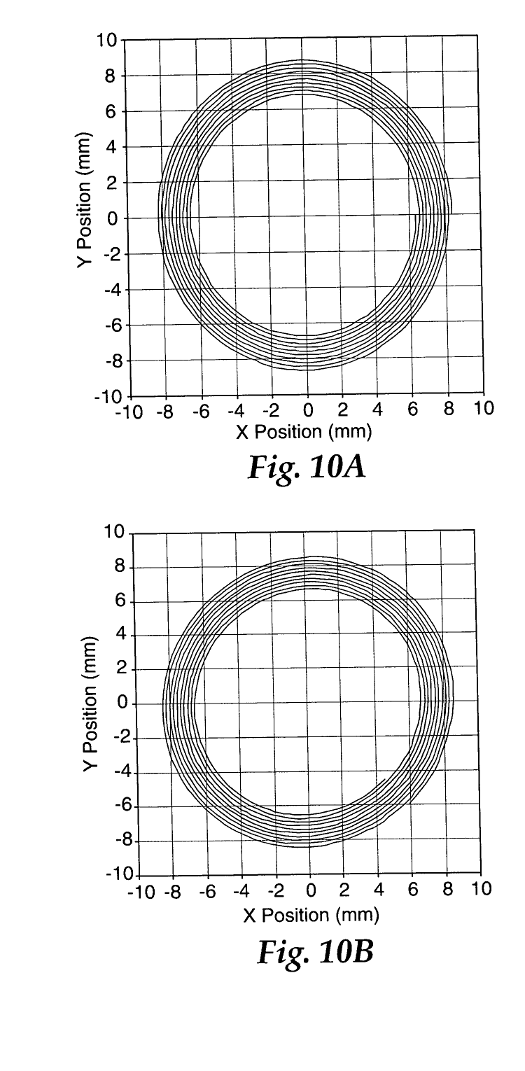

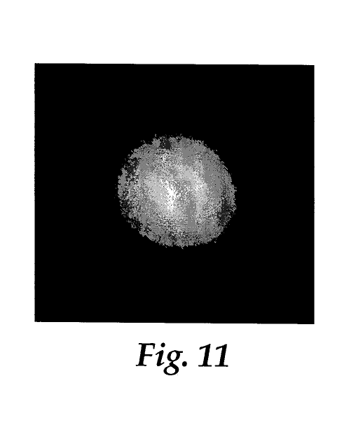

The creation of an angled toric lens with a small torus radius is illustrated in FIGS. 8 and 9A-9C. In this example, an optical fiber with isotropic physical properties was loaded into a collet, with the fiber protruding from the bottom face of the collet by 6.25 mm (0.246 inch). The fiber was drawn across abrasive lapping film in the curvilinear pattern as shown in FIG. 8. The collet to film distance was set at 5.00 mm (0.197 inch). The optical fiber was drawn in 400 cycles across a 0.5 μm diamond lapping film and then 100 cycles across a 0.1 μm diamond lapping film using the same pattern. It should be noted that the curvilinear pattern of FIG. 8 correctly shows the start and end points of the cycles, but the number of cycles illustrated has been reduced for clarity of the Figure. The optical fiber was then removed from the collet, placed in a fiber fusion splice, and subjected to three plasma bursts for 0.5 seconds each at a power setting of 12.0 mA to melt the tip of the lens. Photographs of the resulting lens and farfield pattern are shown in FIGS. 9A-9C.

### EXAMPLE 3

The creation of a conic lens on a fiber with anisotropic physical properties is illustrated in FIGS. 10A-B and 11. In this example, a PM optical fiber (Tiger fiber Type 7129 available from 3M Company of Saint Paul, Minn., U.S.A.) with anisotropic physical properties was loaded into a collet so that the fiber protruded from the bottom face of the collet by 6.25 mm (0.246 inch), with the major axis of the fiber stress ellipse loaded consistently in one direction. The fiber was subjected to a series of nine process stages consisting of drawing the fiber tip across flat abrasive lapping films in a series of true elliptical spiral patterns similar to those shown in FIGS. 10A and B.

The spiral paths used in each process stage are described by a set of X-Y coordinates referenced to an X-Y Cartesian coordinate system lying on the abrasive film. The Y-axis is defined as parallel to the major axis of the fiber stress ellipse as loaded into the collet. The set of X-Y coordinates describing the true elliptical spirals can be described mathematically as follows:
X=x cos(φ)+y sin(φ)
Y=−x sin(φ)+y cos(φ)
where x and y represent the set of Cartesian coordinates describing the spiral in a second x-y Cartesian coordinate system co-located at the same origin as the X-Y coordinate system but whose x-axis is rotated by an angle φ with respect to the X-axis.

The coordinates x and y can be calculated as follows:
x=D cos(Θ) y=D sin(Θ)
where D and Θ are a set of polar coordinates describing the path in a polar coordinate system co-located at the origins of the XY and xy Cartesian coordinate systems, and where Θ=0 represents a direction parallel to the x-axis with increasing Θ moving in a counter clockwise direction towards the positive y-axis. The coordinates D and Θ are related as follows:

$$D ( θ ) = \frac{K}{\sqrt{1 - ( 1 - {K}^{2} ) {cos}^{2} ( θ )}} [ {a}_{0} + ( \frac{{a}_{N} - {a}_{0}}{2 π N} ) ( θ - {θ}_{0} ) ]$$

where, a₀ and Θ₀ are the radial and angular polar coordinates representing the starting point of the path, a_{N} represents the final radius of the spiral (measured at Θ₀), N is the number of cycles required to achieve the final radius, K is the aspect ratio of the ellipse defined as the ratio of the radius of a true ellipse measured at Θ=½π radians divided by the radius of the ellipse measured at Θ=0 radians.

During stage 1, the fiber was drawn across a 0.5 μm diamond grade flat lapping film in a clockwise elliptical spiral pattern defined by the following parameters: φ==0, Θ₀=0, K=1.05, a₀=0.165 inches, a_{f}=0.125 inches, N=200. The spiral pattern was followed by drawing the fiber in 10 cycles around an elliptical pattern defined by the aspect ratio and final radius of the spiral pattern. During stage 2, the fiber was drawn across the same lapping film as stage 1 and in the same pattern as stage 1 but in a counter-clockwise direction with φ=¼π. During stage 3, the fiber was drawn across a 0.1 μm diamond grade film in a clockwise pattern identical to the pattern in stage 1. During stage 4, the fiber was drawn across the same 0.1 μm diamond grade film in a counter-clockwise pattern identical to stage 2. In stages 5, 7 and 9, the fiber was drawn across a cerium-oxide lapping film on a “flocked” backing in a pattern identical to stage 1. In stages 6 and 8, the fiber was drawn across the same flocked cerium-oxide lapping film in a pattern identical to stage 2.

During stages 1-4 the collet to film distance was fixed at 5.3 mm (0.21 inch). During stage 5-8 the collet to film distance was set at 5.8 mm (0.23 inch) and in stage 9 the distance was set at 6.1 mm (0.24 inch). The transitions down to and up from the collet to film distance used in the spirals were handled by drawing the fiber in a helical pattern defined by the aspect ratio and initial radius of the spiral until the collet was moved into the proper vertical position. During the helical transitions a cover film was placed over the abrasive lapping film to avoid the creation of non-uniformities in the fiber lens.

The resulting lensed fiber had a wedge angle of 98.5°, a maximum lens radius of 6.81 μm and a minimum radius of 6.48 μm measured orthogonally to the maximum radius. The farfield pattern of the lens is shown in FIG. 11. The difference between the maximum and minimum lens radii is ˜5%. When running a similar multi-stage process using a circular spiral (K=1.0) on the same fiber, the maximum and minimum radii differed by an average of ˜30%.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. An optical fiber comprising:
a lens integrally formed on an end of the optical fiber, the lens having a finite maximum radius of curvature in a first direction and a finite radius of curvature in a second direction orthogonal to the first direction, wherein the radius of curvature in the first direction is different from the radius of curvature in the second direction, and wherein at least one of the first and second directions is non-orthogonal to a longitudinal axis of the optical fiber.

2. The optical fiber of claim 1, wherein the lens shape is substantially an oblate spheroid.

3. The optical fiber of claim 1, wherein the lens has a continuous curvature.

4. The optical fiber of claim 1, wherein the lens is devoid of discontinuous surfaces.

5. The optical fiber of claim 1, wherein a transverse cross-section of the optical fiber has an anisotropic physical property.

6. The optical fiber of claim 5, wherein the anisotropic physical property includes the bending stiffness of the optical fiber.

7. The optical fiber of claim 5, wherein the anisotropic physical property includes the abrasion resistance of the optical fiber.

8. The optical fiber of claim 5, wherein the optical fiber is a polarization maintaining (PM) fiber.

9. The optical fiber of claim 5, wherein the optical fiber is a polarizing (PZ) fiber.

10. The optical fiber of claim 5, wherein the transverse cross-section is non-circular.

11. A method for forming a microlens on an optical fiber, the method comprising: drawing a tip of an optical fiber over an abrasive media in a spiral curvilinear pattern.

12. The method of claim 11, further comprising stripping an outer coating of the fiber such that a portion of the outer coating remains on the fiber after said stripping.

13. The method of claim 12, further comprising holding the fiber at a position on the fiber such that the portion of the outer coating remaining after said stripping protrudes from an end of a fiber holder, and wherein the fiber drawn of the abrasive media is unsupported bare fiber.

14. The method of claim 11, further comprising maintaining a non-zero contact angle of about 15° or less during said drawing.

15. The method of claim 11, wherein the spiral pattern is selected from the group consisting of substantially oval spirals, substantially elliptical spirals, substantially egg-shaped spirals, substantially pill-shaped spirals, and substantially iron-shaped spirals.

16. The method of claim 11, wherein drawing a tip of an optical fiber over an abrasive media in a spiral curvilinear pattern comprises drawing a tip of an optical fiber over an abrasive media in a substantially oval pattern.

17. The method of claim 11, wherein drawing a tip of an optical fiber over an abrasive media in a spiral curvilinear pattern comprises drawing a tip of an optical fiber over an abrasive media in a substantially elliptical pattern.

18. The method of claim 11, wherein drawing a tip of an optical fiber over an abrasive media in a spiral curvilinear pattern comprises drawing a tip of an optical fiber over an abrasive media in a substantially egg-shaped pattern.

19. The method of claim 11, wherein drawing a tip of an optical fiber over an abrasive media in a spiral curvilinear pattern comprises drawing a tip of an optical fiber over an abrasive media in a substantially pill-shaped pattern.

20. The method of claim 11, wherein drawing a tip of an optical fiber over an abrasive media in a spiral curvilinear pattern comprises drawing a tip of an optical fiber over an abrasive media in a substantially iron-shaped pattern.

21. The method of claim 11 wherein drawing a tip of an optical fiber over an abrasive media comprises drawing a tip of an optical fiber having a transverse cross-section with an anisotropic physical property.

22. The method of claim 11 wherein drawing a tip of an optical fiber over an abrasive media comprises drawing a tip of an optical fiber over a flat abrasive media.

23. The method of claim 11, further comprising holding the optical fiber at a location spaced apart from the tip of the optical fiber.

24. The method of claim 23, further comprising bending the optical fiber as the tip is drawn over the abrasive media.

25. The method of claim 11, further comprising controlling a pressure exerted on the tip of the fiber.

26. A method for forming a microlens on an optical fiber, the method comprising:
drawing a tip of an optical fiber over an abrasive media in a curvilinear pattern that is selected from the group consisting of substantially oval patterns, substantially elliptical patterns, substantially egg-shaped patterns, substantially pill-shaped patterns, and substantially iron-shaped patterns.

27. The method of claim 26, further comprising maintaining a non-zero contact angle of about 15° or less during said drawing.

28. The method of claim 26, further comprising holding the optical fiber at a location spaced apart from the tip of the optical fiber.

29. The method of claim 28, further comprising bending the optical fiber as the tip is drawn over the abrasive media.

30. The method of claim 26, further comprising controlling a pressure exerted on the tip of the fiber.
